(19) United States
(12) Patent Application Publication
(10) Pub. No.: US 2014/0001761 A1
(43) Pub. Date: Jan. 2, 2014

(54) ADAPTIVE HYDROKINETIC ENERGY HARVESTING

(71) Applicants: Lisa Mauck Weiland, Pittsburgh, PA (US); William W. Clark, Wexford, PA (US); Daniel G. Cole, Pittsburgh, PA (US)

(72) Inventors: Lisa Mauck Weiland, Pittsburgh, PA (US); William W. Clark, Wexford, PA (US); Daniel G. Cole, Pittsburgh, PA (US)

(21) Appl. No.: 13/622,855

(22) Filed: Sep. 19, 2012

Related U.S. Application Data
(60) Provisional application No. 61/536,377, filed on Sep. 19, 2011.

(51) Int. Cl. F03B 13/10

(52) U.S. Cl. CPC F03B 13/10
USPC 290/54

(57) ABSTRACT

An energy harvester for producing useable energy from fluid motion of a fluid medium, the energy harvester comprising a support structure affixed directly or indirectly to a foundation or mounting; wherein the support structure comprises one or more legs; a morphable moving element movably supported by the support structure for oscillating movement along an axis of the support structure, wherein the axis is substantially perpendicular to a direction of the fluid motion; a biasing element or spring for biasing the morphable moving element in a first direction along the axis; and a converter for converting mechanical energy of the morphable moving element to useable energy.

### CROSS REFERENCE TO RELATED APPLICATIONS

This application claims priority to, and the benefit of, the U.S. provisional patent application U.S. Patent Application Ser. No. 61/536,377 entitled “Adaptive Hydrokinetic Energy Harvesting” filed on Sep. 19, 2011, which is hereby incorporated by reference in its entirety for all purposes.

### FIELD OF INVENTION

The present disclosure relates to devices and methods for adaptive energy harvesting from fluid motion.

### BACKGROUND OF THE INVENTION

Traditional hydroelectric energy strategies convert potential energy from high head water bodies into electrical energy. Hydrokinetic energy strategies instead seek to convert kinetic energy into electrical energy; this includes tidal currents, wave energy, and river flow. Of these, technologies aiming to convert river flow energy—especially in low head and/or low power rivers—is least developed despite the significant cumulative magnitude of the resource.

Most population centers are situated on or directly adjacent to reliable water sources. Thus, unlike some energy sources, hydrokinetic energy sources are co-located with the consumer. It is not surprising that the US Department of Energy's (DoE) has included growing interest in identifying and harvesting hydrokinetic energy as a renewable energy source. For instance, in 2004 a DoE study was released that preliminarily assessed the untapped US energy resource available in rivers and in streams, including the cumulative contributions from low head (<30 ft) and low power (<1 MW) sources. EERE, DOE. DOE/ID-11111 Water Energy Resources of the United States with Emphasis on Low Head/Low Power Resources. s.l.: Wind and Hydropower Technologies, 2004.

In 2005 a DoE workshop was hosted to identify existing hydrokinetic concepts, natural resources, environmental impacts, and development needs. Savitt Schwartz, ed. Proceedings of the Hydrokinetic and Wave Energy Technologies Technical and Environmental Issues Workshop. Oct. 26-28, 2005. Washington, D.C.: Prepared by RESOLVE, Inc., Washington, D.C., 2006.

The workshop failed to identify an existing technology base for translating river flow to electric power. The workshop proceedings describe hydrokinetic energy generation potential as “gargantuan.” The problem had not been solved by 2010 as shown by proposal solicitations by the DoE the “Marine and Hydrokinetic Technology Readiness Advancement Initiative.” An objective of the solicitation was to “stimulate and support technological innovation for the investigation and advancement of innovative water power technologies . . . .” DE-FOA-0000293. Marine and Hydrokinetic Technology Readiness Advancement Initiative—Financial Assistance Funding Opportunity Announcement). s.l.: U.S. Department of Energy, Golden Field Office, 2010.

The absence of viable river hydrokinetic energy harvest strategies represents a clear and important technology gap. While some tidal-based harvesting concepts that have been developed in the past thirty years were proposed for river energy harvesting, each has significant limitations that have prevented its implementation in rivers and streams. New harvesting concepts, or improvements to existing concepts are needed in order to effectively tap the large potential of hydrokinetic energy.

Morphing: Dynamic responses resulting from fluid-solid interactions, such as lift, are a function of both the fluid flow rate/type and geometry/properties of the solid body; and in situ manipulation of solid body geometry/properties (“morphing”) may be used to maintain optimum response even as the flow rate/type varies. Morphing is a bio-mimetic concept pursued primarily by the aerospace community. A commonly described example of morphing comes from observations of predatory birds. For example, a raptor widely stretches its wings while hovering in search of prey, but tucks them close to its body when swooping down in pursuit. Morphing aircraft development seeks to mimic this kind of performance enhancing shape change by radically ‘morphing’ an aircraft's wing area, geometry, orientation, and in some cases material properties while in flight. For instance, when a control surface is shape- or property-morphed, aerodynamic response is altered.

Any approach that seeks to address this design goal may be categorized as morphing. Strategies vary substantially, including but not limited to: (i) entirely mechanical/kinematic solutions such as the ‘swing wing’ of the F-14; (ii) application of materials with tailored anisotropy which deform into favorable shapes under varied aerodynamic loads; Passive approach of controlling twist in composite tilt-rotor blades (Proceedings Paper). Lake, John B. Kosmatka & Renee C., SPIE—Bellingham, Wash.: Proceedings of SPIE Volume: 2717, 1996. ISBN: 9780819420923; (iii) application of thermal shape memory materials which antagonistically switch between two geometric configurations; Proposals for Controlling Flexible Rotor Vibrations by Means of an Antagonistic SMA/Composite Smart Bearing. Daniel J. Inman, Matthew P. Cartmell, A. W. Lees, Th. Leize, L. Atepor, Pages 29-36, s.l.: Applied Mechanics and Materials, October 2006, Vols. 5-6: Modern Practice in Stress and Vibration Analysis VI; (iii) chemo-mechanical strategies where material properties and dimensions evolve via introduction/removal of a local stimulus, theoretically with infinite degrees of freedom; Investigation on High Energy Density Materials Utilizing Biological Transport Mechanisms. Sundaresan, V. B., Tan, H., Leo, D. J. and Cuppoletti, J., Anaheim, Calif.: ASME—IMECE, Nov. 15-21, 2004. Proc 69, pp. 55-62 A; and (iv) application of property changing materials, also with theoretical infinite degrees of freedom, where a combination of mechanical load and property-change stimulus, such as a specific wavelength of light, lead to shape morphing. Light Activated Shape Memory Polymer (LASMP) Characterization. Weiland, Richard Beblo and Lisa Mauck, 1, s.l.: ASME Journal of Applied Mechanics, 2009, Vol. 76.

While the approaches to morphing are varied, they can be generally categorized as either passive or active. The majority of strategies to date have been active, for example, an aircraft employing some energy source and control system in order to morph, or a predatory bird's use of its nervous and muscular systems. In these cases the advantages of morphing have to be established in contrast to the disadvantages of added complexity and existence of a parasitic power drain. Conversely, a passive morphing system requires no on-board energy drain or control system. An example of this is rotorcraft blades fabricated with fiber composite layups such that higher rotational speeds induce a desirable blade twist caused entirely by the increased aerodynamic load. The strategic use of fiber composites enables a directional stiffness variation and ultimately a desired twist in the airfoil at increased aerodynamic loads. Application of variable modulus strategies preferably induces passive shape change of the control surface in response to changes in flow rate.

In addition, it would be desirable to provide an improved adaptive or morphable hydrokinetic or hydroelectric energy harvester to overcome the deficiencies listed above. These and other advantages of the present disclosure will be appreciated by reference to the detailed description of the preferred embodiment(s) that follow.

### BRIEF SUMMARY OF THE INVENTION

In a first preferred aspect, the present disclosure is directed to an energy harvester for producing useable energy from fluid motion of a fluid medium, the energy harvester comprising: a support structure affixed directly or indirectly to a foundation or mounting; wherein the support structure comprises one or more legs; a morphable moving element movably supported by the support structure for oscillating movement along an axis of the support structure, wherein the axis is substantially perpendicular to a direction of the fluid motion; a biasing element or spring for biasing the morphable moving element in a first direction along the axis; and a converter for converting mechanical energy of the morphable moving element to useable energy.

In accordance with another aspect of the energy harvester of the present disclosure, one or more of the morphable moving element, the biasing element or spring is capable of one or more of not morphing, active morphing, passive morphing, intermittent active and/or passive morphing, continuous active and/or passive morphing, cyclic active and/or passive morphing.

In accordance with an additional aspect, the energy harvester of the present disclosure may further comprise a sensor for providing data responsive to a predetermined condition of operation of the energy harvester; and a controller for controlling active morphing of the morphable moving element and/or the biasing element in response to the data from the sensor.

In yet another aspect of the energy harvester of the present disclosure, the oscillating movement comprises galloping movement of the morphable moving element.

In another aspect of the energy harvester of the present disclosure, the support structure comprises two legs, spaced apart and substantially parallel to one another wherein the morphable moving element is movably supported by and between the two legs.

In an additional aspect of the energy harvester of the present disclosure, the support structure has only a single leg of single-piece or multi-piece construction and such single leg may define a streamlined portion near or contiguously with a location on the leg where the morphable moving element is attached to the single leg.

In another aspect of the energy harvester of the present disclosure, the oscillating movement of the morphable moving element results from vortex induced fluid motion or galloping fluid motion or a combination thereof.

In an additional aspect of the energy harvester of the present disclosure, the morphable moving element comprises areas or components wherein at least two of the areas and/or components have different structural stiffness values.

In yet another aspect of the energy harvester of the present disclosure, the converter comprises a generator, an electromotive induction generator or an electroactive polymer generator.

In another aspect of the energy harvester of the present disclosure, the morphable moving element experiences active and/or passive morphing dependent upon a variable parameter of the fluid motion comprising velocity or flow type.

In an additional aspect of the energy harvester of the present disclosure, the morphable moving element experiences active and/or passive morphing at one or more points along an oscillation cycle traveled by the morphable moving element.

In another aspect of the energy harvester of the present disclosure, the morphable moving element experiences active and/or passive morphing continuously, intermittently or cyclically along an oscillation cycle traveled by the morphable moving element.

In yet a further preferred aspect, the present disclosure is directed to an energy harvester for producing useable energy from fluid motion of a fluid medium, the energy harvester comprising: a support structure affixed directly or indirectly to a foundation or mounting; wherein the support structure has only a single leg comprising single-piece or multi-piece construction; a moving element movably supported by the support structure for oscillating movement along an axis of the support structure, wherein the axis is substantially perpendicular to a direction of the fluid motion; a biasing element or spring for biasing the moving element in a first direction along the axis; and a converter for converting mechanical energy of the moving element to useable energy.

In another aspect of the energy harvester of the present disclosure, the moving element is non-morphable.

In an additional aspect of the energy harvester of the present disclosure, one or more of the moving element, the biasing element or spring is capable of one or more of not morphing, active morphing, passive morphing, intermittent active and/or passive morphing, continuous active and/or passive morphing, cyclic active and/or passive morphing.

In another aspect of the energy harvester of the present disclosure, the moving element comprises areas or components wherein at least two of the areas and/or components have different structural stiffness values.

In yet another aspect of the energy harvester of the present disclosure, the single leg defines a streamlined portion near or contiguously with a location on the leg where the moving element is attached to the single leg.

In yet an additional preferred aspect, the present disclosure is directed to a method for harvesting energy comprising the steps of: placing a morphable moving element or prime mover in a flowing fluid; morphing the moving element or prime mover; and transforming the motion of the moving element or prime mover in response to the flowing fluid to electrical energy.

In another aspect of the method of the present disclosure, the morphing comprises active morphing and/or passive morphing.

Many other variations are possible with the present disclosure, and those and other teachings, variations, and advantages of the present disclosure will become apparent from the description and figures of the present disclosure.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a schematic view of a preferred single-legged kinetic energy harvester for producing useable energy from fluid motion of the present disclosure;

FIG. 2 is an illustration of a preferred two-legged galloping kinetic energy harvester of the present disclosure;

FIG. 3 is an illustration of another preferred two-legged galloping kinetic energy harvester of the present disclosure;

FIG. 4A illustrates yet an additional preferred embodiment of a two-legged galloping energy harvester of the present disclosure;

FIG. 4B illustrates a preferred cross-sectional shape of a morphing prism as the moving element of a preferred embodiment of a two-legged galloping energy harvester of the present disclosure thereof;

FIG. 5A illustrates the limit cycle oscillation amplitude characteristics for a preferred adaptive hydrokinetic energy harvester of the present disclosure;

FIG. 5B illustrates the limit cycle oscillation power characteristics for a preferred adaptive hydrokinetic energy harvester of the present disclosure;

FIGS. 6A and 6B are a cross-sectional views of passive morphing as a function of flow rate for a preferred adaptive hydrokinetic energy harvester of the present disclosure, with increasing concavity (FIG. 6A) and decreasing concavity (FIG. 6B);

FIGS. 7A-E are schematic views of a preferred morphable moving element or morphable prime mover for a preferred adaptive hydrokinetic energy harvester of the present disclosure;

FIGS. 8A and 8B are schematic views of preferred adaptive hydrokinetic energy harvesters of the present disclosure;

FIGS. 9A and 9B are illustrations of a preferred adaptive hydrokinetic energy harvester of the present disclosure showing cross section control as a function of flow rate;

FIG. 10 illustrates a preferred embodiment of a turbine energy harvester of the present disclosure;

FIG. 11, FIG. 11A, FIG. 11B and FIG. 11C illustrate a preferred fluttering flag kinetic energy harvester of the present disclosure;

FIG. 12 illustrates a preferred embodiment of a wing mill energy harvester for use with the present disclosure.

FIGS. 13A, 13B and 13C are cross-sectional views showing wingmill kinetic energy harvester moving element control surface versus angle of attack for a preferred wingmill kinetic energy harvester for use with the present disclosure; and

FIGS. 14A-C show a preferred morphable moving element morphing with increasing flow rate.

### DETAILED DESCRIPTION OF PREFERRED EMBODIMENT(S) OF THE INVENTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such preferred embodiments of the inventive subject matter may be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense, and the scope of the inventive subject matter is defined by the appended claims and their equivalents.

The power extraction potential of a river hydroelectric energy harvest system is normally a function of water flow rate (cubic feet per second) and hydraulic head (feet). With sufficient hydraulic head, conventional turbines are favored. A sub-optimal option for low hydraulic head situations is to use non-morphing, existing turbine technologies to harvest a portion of the shallow site energy while reducing negative impacts. A superior option is to develop a new harvesting paradigm appropriate to shallow and deep sites which thereby enables widespread, long-term implementation. We have found the latter option, which enhances all hydroelectric energy harvest, enables energy harvest from rivers. These and other advantages of the invention will be appreciated by reference to the preferred embodiment(s) that follow.

Table 1 provides discrete flow data measurements from the U.S. Geological Survey (“USGS”) for a few specific times of the year (not averages) of the Kiski River, a shallow but fast flowing river. The data shows the river has a significant variation in flow rate (˜0.3 to ˜1.3 m/s). Zaar, Linda F., Long-form measurement discharge summary for station number 03048500 kiskiminetas river at Vandergrift, Pa. s.l.: Via e-mail correspondence with USGS [lfzarr@usgs.gov].

TABLE 1
Kiski River Flow Rate

| Date | Flow Velocity (m/s) |
|---|---|
| Oct. 01, 2007 | 0.26 |
| Dec. 18, 2007 | 1.51 |
| Jan. 24, 2008 | 0.53 |
| Mar. 11, 2008 | 1.64 |
| Apr. 28, 2008 | 1.15 |
| Jun. 26, 2008 | 0.32 |
| Aug. 07, 2008 | 0.30 |

Previsic and Bedard conducted an assessment of energy harvesting rivers in Alaska, including the Tanana River at Big Delta (Station ID: 15478000 according to USGS). Like the Kiski River, the Tanana River displays a significant flow rate range, from a low of ˜2.5 ft/s (0.8 m/s) in the winter to ˜5.9 ft/s (1.8 m/s) in the summer. Based upon the wide flow rate range seen in these rivers, it is desirable for a robust river hydroelectric energy harvest system to display efficient performance over a broad range of flow rates. Bedard, M. Previsic and R., River in-stream energy conversion (risec) characterization of Alaska sites. s.l.: EPRI-RP-003-Alaska, February 2008.

Morphing, for the purposes of this application, is the inducing of a prescribed deformable change to a body, a change in material property of a body, or a combination thereof. The intent of morphing, for the purposes of this application, is to optimize specific performance characteristics, such as energy harvesting, of the various preferred embodiments of the present disclosure. As applied herein, morphing favorably affecting dynamics via increased mechanical motion (energy) may be applied to enhance energy harvest. Specifically, morphing in hydro-energy harvesting devices is herein shown to (i) enhance performance of existing hydroelectric energy device concepts, and (ii) enable harvest in locations that would otherwise remain untapped. Insertion of morphing strategies into nontraditional technologies may enable harvest from rivers that would otherwise be inaccessible or economically unfeasible.

Galloping Hydrokinetic Energy Extraction Device (GHEED). A phenomenon known as galloping has been observed in electrical power lines in the presence of rain or ice. As wind blows across the lines, the rain or ice serves to alter the aerodynamic flow of air around the cable. Aeroelastic instability is created, and galloping occurs when these oscillations increase to a sustained limit cycle oscillation. In the case of electric power lines this oscillation is unwanted, but in the case of energy generation such oscillations may be harnessed to produce electricity.

Gallop is a vibration induced in a structure by the interaction between the fluid and the structure. It is an instability created by this fluid-structure interaction that results in an oscillatory motion that grows to a limit-cycle oscillation. The nature of the instability and the limit-cycle are determined by the nonlinear fluid-dynamic characteristics of the fluid-dynamic body (e.g., prism or foil). Vortex shedding is not a requisite condition to induce gallop. The vibration itself is a single mode vibration (one degree of freedom).

The majority of the investigations of galloping phenomenon have been in air for power line and cable stay galloping. In principle, the water case is no different hydrodynamically; the flow is still incompressible and viscous effects are accounted for in measured lift and drag. In the oscillating case, however, the increased density of the water results in heavy fluid loading, which has the effect of increasing the effective mass of the prism, and lowering the frequency of oscillation. This oscillation can be used in a river flow to convert flow energy to mechanical energy and act as the moving element harvesting energy.

As shown in FIG. 14, a sheet of latex was stretched over a halved piece of steel piping. The left photo of FIG. 14 shows a rectangular latex morphing surface with approximate dimensions of 151 mm×52 mm×0.2 mm. The latex properties were measured and found to be 1.1 MPa. The black electrical tape is present to highlight the back edge of the prism for photography. The right photo in FIG. 10 shows the same prism with air flow. The flow was set at approximately 2 ft/s (0.601 m/s) and the morphing prism was placed in the flume. A vertical line, perpendicular to the flow was drawn to correspond to the “morphing edge” of the prism. The flow was turned on, and the deflection of the latex morphing surface was measured. The flow was turned on and off over five cycles, and the five measurements taken resulted in an average deflection of roughly 10 mm. The maximum possible deflection of the morphing surface may be estimated analytically for comparison and design purposes. Using an assumption of uniform flow, the dynamic pressure imposed on the morphing surface due to the flow may be classically calculated as:

$$p = \frac{{u}^{2} {ρ}_{fl} }{2}$$

where u is the velocity in the x-direction, ρ_{fl} is the density of water. Membrane deformation may be estimated as one describes the stress in a thin walled cylindrical pressure vessel where hoop stress is given by:

$$\text{?} = \text{?} - \text{?} ( \text{?} - \text{?} ) = \text{?}$$

$$\text{?} \text{indicates text missing or illegible when filed}$$

where ρ_{d} is the radius of curvature of the deformed membrane. Taking longitudinal stress as half of hoop stress, radial stress as negligible, assuming linear elasticity applies, and that the latex membrane is incompressible, the hoop strain can be estimated as:

$$\text{?} = \text{?}$$

$$\text{?} \text{indicates text missing or illegible when filed}$$

The deformed, arc-shaped membrane therefore has length:
X_{f}=(1−εₕ)Xᵢ where Xᵢ is the undeformed membrane length between the half circular supports.

This deformation is therefore analogous to that of an arc S defined by angle θ within a circle of radius R, where the classic arc mensuration formulas may be related to membrane geometry:

$$\begin{matrix}S = R θ \\ = {X}_{f} \\ = {ρ}_{d} θ\end{matrix}$$

$$\begin{matrix}a = 2 R sin ( \frac{θ}{2} ) \\ = 2 \sqrt{h ( 2 R - h )} \\ = {X}_{i}\end{matrix}$$

Here a (analog to Xᵢ) describes the straight line distance across the arc S and h describes the sought membrane defoimation. The above establishes that there are 3 equations and 3 unknowns (h, R, and θ). For the inlet flow rate of 2 ft/s, R (membrane radius of curvature) is found to be 75 mm and membrane deflection h is subsequently found to be 5 mm. The error as compared to the experimental observation of 10 mm is attributed to imperfect membrane attachment. In various embodiments, the membrane type (stiffness) or thickness is chosen to achieve more or less curvature. Similarly, physical or geometric property manipulations may be designed to achieve alternate target shapes.

As demonstrated for one control surface, similar phenomena may be manipulated for any other control surface.

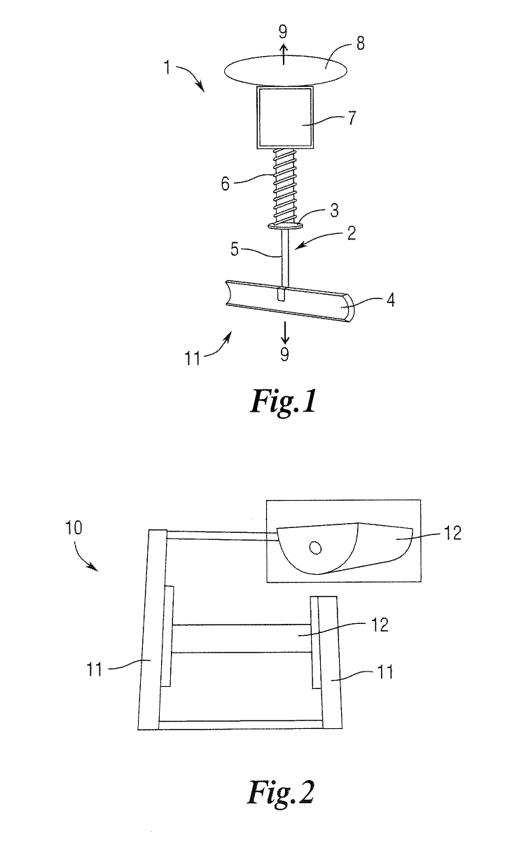

The galloping mechanism can be used to generate electricity from the kinetic energy of flowing water. A preferred galloping mechanism energy harvester 1 of the present disclosure is shown in FIG. 1 comprising a support structure 2 affixed directly or indirectly to a foundation or mounting 8 (shown affixed indirectly to mounting 8 via generator 7); wherein the support structure 2 has only a single leg 3 comprising single-piece or multi-piece construction; a moving element 4 movably supported by the support structure 2 for oscillating movement along an axis 9 of the support structure, wherein the axis 9 is substantially perpendicular to a direction 11 of the fluid motion; a biasing element or spring 6 for biasing the moving element 4 in a first direction along the axis 9 (down along axis 9 as viewed in FIG. 1); and a converter 7 for converting mechanical energy of the moving element 4 to useable energy. The generator 7 produces electrical energy in response to motion of the moving element 4. The moving element 4 is preferably morphable and may morph actively or passively as described herein and/or to affect or change the fluid-structure interaction of the moving element 4. In preferred embodiments, the galloping energy harvester 1 is oriented in a flowing fluid such that the fluid creates the motion of the moving element 4. Morphable moving element 4 is capable of one or more of not morphing, active morphing, passive morphing, intermittent active and/or passive morphing, continuous active and/or passive morphing or cyclic active and/or passive morphing. Moving element 4 also may be non-morphing or non-morphable.

The preferred motion of the moving element 4 of the galloping energy harvester 1 is a galloping motion. At times, the motion of the galloping energy harvester 1, preferably may also or instead comprise an oscillation of the moving element 4 on an axis 9, or may comprise a linear motion of the axis 9 of the moving element 4.

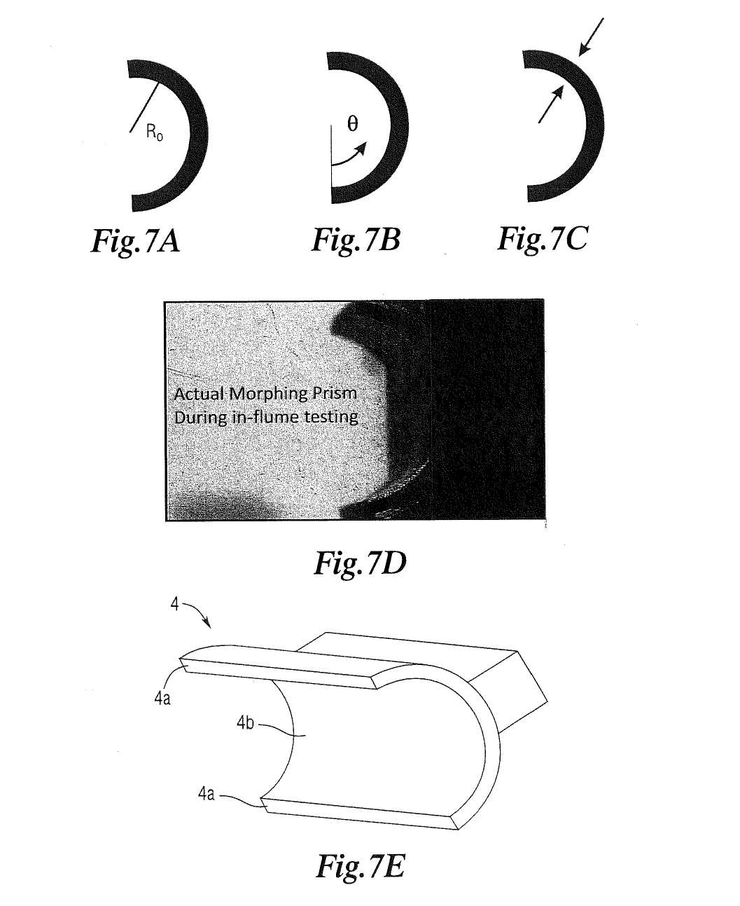

In some preferred embodiments, the morphing of the moving element 4 is passive, while in other preferred embodiments, the morphing of the moving element 4 is active. Morphing may comprise a variation of one or more of a change in cross-sectional shape, cross-sectional area, and/or a change to surface texture of the moving element 4 or other component(s) of the energy harvester 1. In addition, morphing can relate to a change to the a structure of the energy harvester 1 such as stiffness of the moving element 4, a biasing element or spring 6, a spring constant, or an element in the flowing fluid upstream of the moving element 4. As shown in FIG. 7, moving element 4 may comprise different areas, sections or components 4a and 4b having different structural stiffness values designed to produce or enhance active and/or passive morphing of moving element 4. Such differing structural stiffness values of the different areas, sections or components of the moving element 4 may be created through the use of materials having different stiffness values, different thicknesses, different compositions, etc. Morphing may be continuous, or may be intermittent. Active morphing may require an actuator. Active morphing of a material property may not require an actuator. Energy input may be required to morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions.

The galloping energy harvester 1 may be a single unit or a plurality of units. The units may be placed permanently in the fluid flow, or the units may be temporary or portable.

The galloping energy harvester 1 is used by placing it in a flowing fluid. The orientation of the flowing fluid is such that the moving element 4 is placed in motion by contact with the flowing fluid. Active and/or passive morphing may transpire and the mechanical energy of the moving element 4 is transfoimed to electrical energy by means of a generator 7 which is in communication with the moving element 4.

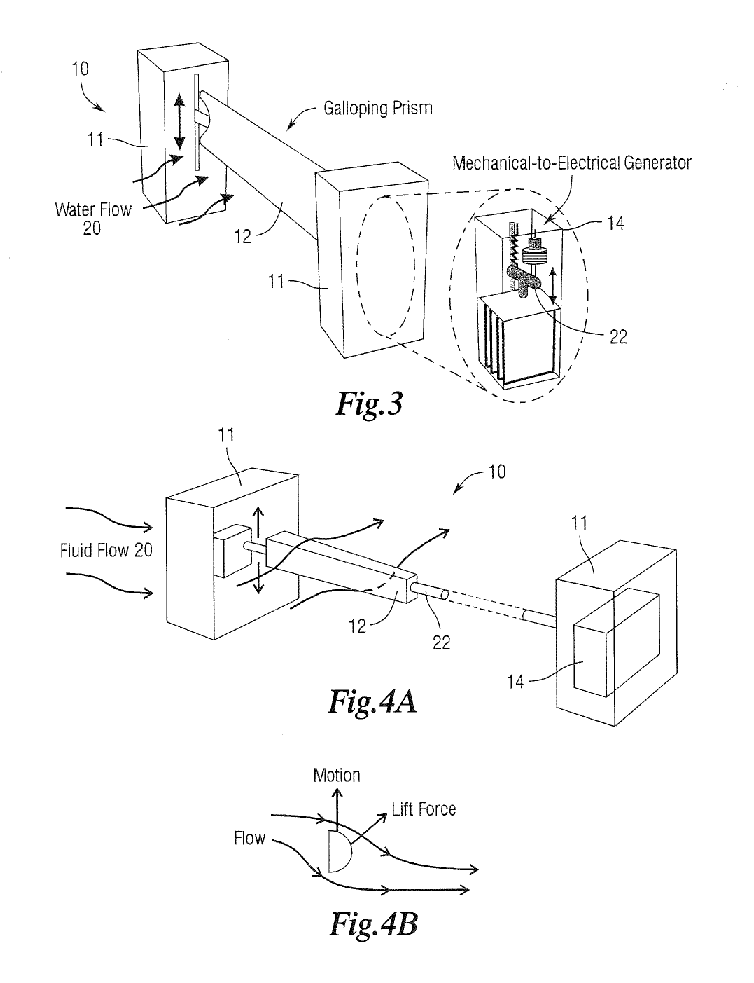

A preferred energy harvester 10 having a support comprising two legs 11, morphable moving element 12 movably supported and suspended by one or more biasing elements or springs (not shown) support is shown in FIG. 2. The geometry and characteristics of such a device allow it to harvest energy from sources and in environments that are not appropriate or suitable for traditional water turbines. Such a device may include a semi-rigid prism 12 (with little or no transverse deflection) movably suspend by biasing elements or springs (not shown) on supports 11 as illustrated in FIG. 3 and in FIG. 4. The prism 12 and supports 11 behave like a spring-mass system with its natural frequency being the frequency of oscillation, and the hydrodynamic characteristics are determined by the cross-sectional shape. Harvestable power capacity, based on existing understanding, is estimated at 200 to 600 watts/square meter of prism area. A modular generator on the scale of a kilowatt output is anticipated resulting in a prism area of 1 m×2 m. Modular design allows for multiple units to be installed for greater capacity and facilitates development of portable systems.

The fluid-structure interaction of the prism with the surrounding flow determines the resulting limit cycle oscillation used to drive electricity generation. The oscillation of the device is a single mode vibration. The hydrodynamic interaction with the device occurs through the lift, L:

L=½ρV²SC_{L}(α)

a function of flow density, ρ, flow velocity, V, the prism's surface area, S, and the coefficient of lift, C_{L}(α). C_{L}(α) is a non-linear function of the angle of attack. The angle of attack depends upon the motion of the prism relative to the surrounding flow: α=\dot{y}/V. The dependence of motion due to forces is described by the transfer function relating force f and velocity \vec{y}. The force f has two contributions: one from the DEG generator, and the other from the lift resulting from fluid-flow across the device.

Analyzing the motion of the device, including non-linear effects of the lift, is difficult and can often only be accomplished using numerical simulations. However, the technique of describing functions (also called harmonic balance) can be used to determine the characteristics of the oscillation in non-linear systems analysis such as amplitude-dependent frequency response functions.

Using this technique, the coefficient of lift can be expanded as a polynomial with coefficients aᵢ, including enough terms to characterize the changes in curvature over the operating range of interest. When the galloping device undergoes sinusoidal motion at frequency ω, the describing function is

N( Y̅,β)=(α₁−β)+¾α₃ Y̅²+⅝α₅ Y̅⁴+ 35/64α₇ Y̅⁶

where β=cV/(qS) and Y̅=ωY/V are normalized coefficients (where c is the equivalent damping factor for the generator and q is dynamic pressure and Y is the amplitude of displacement). The system will oscillate at the structural system's natural frequency: ω=ωₙ=\sqrt{k/m}, where k is the damping coefficient and in is mass. The roots of N( Y̅,β)=0 determine the amplitude at which the hydro-elastic system operates, and these amplitudes depend upon current and past values of β. In order to evaluate the power generated, using the coefficient of performance, the describing function can be transformed so that

35/64α₇C_{P}³+ 5/16α₅βC_{P}²+ 3/16α₃β²C_{P}+⅛β³(α₁−β)=0

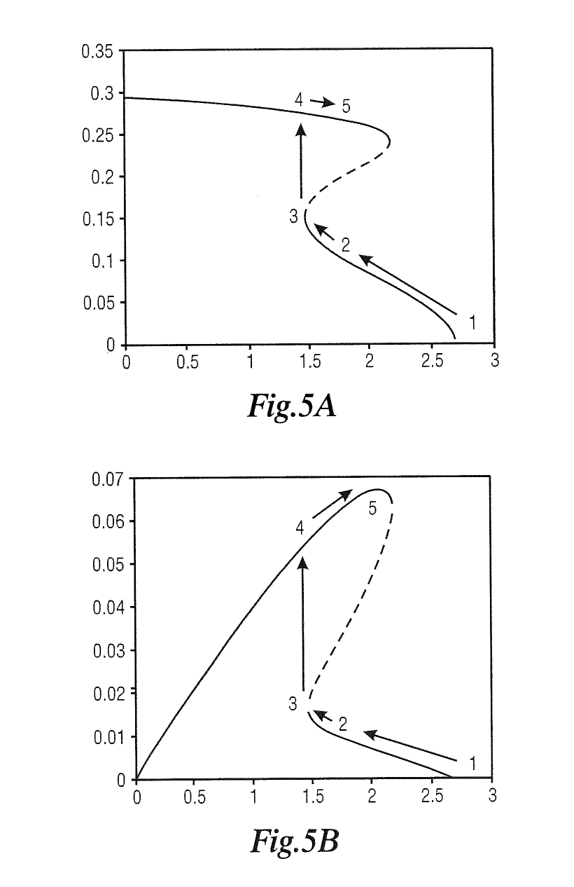

The roots of this polynomial determine the power generation, where the locus of roots for Cₚ depend upon β. FIG. 5b shows C_{P} versus β for a square prism. For certain values of β the response has multiple stable limit-cycles that correspond to the multiple roots of the polynomial given above.

When considering the use of such a device for hydrokinetic energy harvesting, one preferably operates at a high value of C_{F}. To arrive in the basin of attraction for that limit cycle it is preferable to control the flow history of the device. FIG. 5 illustrates that the level of performance can be changed using β as tuning factor to arrive at a maximum Cₚ. More preferably, the performance may be tuned for different operating conditions by changing the shape of the prism, thus altering the coefficients aᵢ in the describing functions.

FIGS. 5a and 5b show the limit cycle oscillation (FIG. 5a) amplitude and (FIG. 5b) power characteristics for a square prism. The operating point can change based upon the history of the flow speed and the electrical load. The non-dimensional parameter β=2c/ρV S describes the flow/load condition. At low speeds β is large, the device is stable, and produces no power: condition 1. As speed increases β decreases and the operating point follows the lower branch to condition 2, this is a low amplitude LCO. The upper branch can be reached by changing the load. If the load is decreased, lowering β, the operating point changes to condition 3 where the amplitude jumps to condition 4 on the upper branch. From there the load can be increased to condition 5, the peak power performance point. The dashed line corresponds to an unstable limit cycle.

Passive Shape Change in the GHEED. Shape change of the prism enables the device to work efficiently at a variety of water flow speeds and/or types. The dynamic response is a function of the geometry of the excited surface. For instance, flow impinging on the flat side of a half-circular cross section can result in gallop, however flow impinging on the opposite circular surface will not. Because galloping has traditionally been viewed as undesirable, previous studies have sought to introduce geometries that reduce/eliminate this response rather than enhance it. Here, it is preferred to enhance gallop, and more preferably, to optimize power generation for a various flow rates. To achieve this, the control surface geometry may have to vary with flow rate. Furthermore, the optimum shape will change depending on the flow velocity as most favorable for creating the hydrodynamic instability and sustaining the oscillations at a magnitude and frequency favorable to power generation for the varied flow rate environment of a river. First, the degree of the hydrodynamic instability changes with flow condition and this directly affects the amount of energy that can be harvested. Second, the amplitude of the oscillation depends upon the non-linear characteristics of the hydrodynamics, which further depends directly upon the shape of the prism.

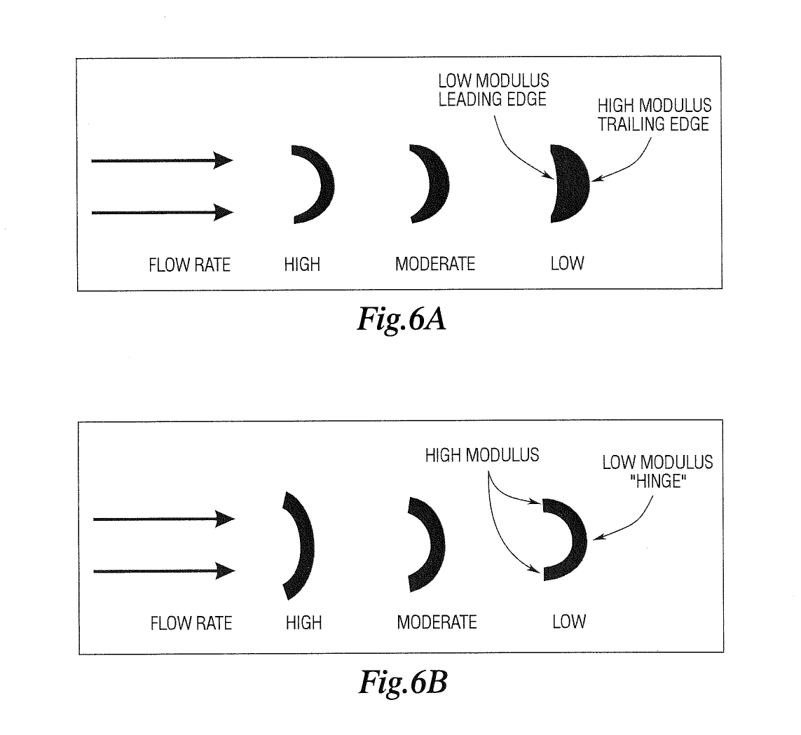

FIGS. 6a and 6b illustrates passive shape change. Hydrodynamics of the prism determines the fluid-structure interaction and the characteristics of the limit cycle oscillation. Changing the shape of the prism changes these hydrodynamics. Different shapes would be most appropriate at different flow rates and electrical loads.

Oscillations of the device may have adverse effects on the device's ability to change shape passively under hydrodynamic loads, which will also oscillate. This may result in asymmetric deformation and reorientation of the control surface. To mitigate the onset of asymmetry and/or control surface twist, the power harvester preferably may use composites strategies akin to those in rotorcraft.

The enhanced repeating motion of a morphable galloping control surface may be coupled to any mechanical-to-electrical generator, so long as the damping of the generator is appropriately considered in the design decisions of any specific GHEED. For purposes of illustration, the application of an electromagnetic induction (EMI) generator, or an electroactive polymer (EAP) generator, or a combination of the two is offered here.

For EMI energy conversion, conversion of mechanical energy to electrical energy may be performed using a gyrator with the transformation of force/velocity to voltage/current described by θ=κl and ν=κ\dot{x}, where κ is the torque constant and back emf constant. The storage or distribution of electrical energy can be modeled as a resistive load: ν=Ri. When combined with the gyrator equations the force/velocity relationship seen from the mechanical side is:

$${f}_{e} = \frac{{κ}^{2}}{R} \dot{x} which is a damper with coefficient c = \frac{{κ}^{2}}{R}$$

The instantaneous power is p(t)=c\dot{x}²(t) and the generation of power will be greatest when the velocity is at a maximum.

For sinusoidal motion of the device, the instantaneous power oscillates with a frequency double the device's natural frequency; as such, the peak power is a maximum twice per cycle. For sinusoidal motion with amplitude X, the average power delivered to the load is:

P=½c(ωX)²

Noting that the damping coefficient directly affects the amplitude and frequency of the galloping response, the EMI generator preferably is impedance matched to the dynamics of the GHEED.

For EAP energy conversion, electricity may be generated through strain of the material, which displaces internal dipole moments and generates charge on surface electrodes. The capacitance of the material and charge generated relate directly to the energy generated, and the collection of this charge each cycle results in power generation. EAP efficiency is much less sensitive to the frequency of excitation than conventional EMI generators are, preferably results in reduced mechanical components requirements, reduced system complexity and reduced maintenance.

For EAPs the conversion of mechanical energy to electrical energy is made using a transformer with the transformation of force/velocity to voltage/current described by ƒ=θv and i=θ\dot{x} and where θ is the electromechanical coupling constant (as a function of the design of EAP device). The charge generated is q=θx and is proportional to displacement.

EAPs are preferably attached directly to a load in a fashion similar to EMI. More preferably, peak harvest, and subsequently peak damping of the galloping motion occur in a sense out-of-phase with that of EMI because EAPs generate electricity with strain, they produce peak power when deflection is maximized, compared to the EMI case where peak power occurs at maximum velocity. Thus, in more preferred embodiments, energy is harvested by application of a switched capacitor.

In a switched capacitor arrangement for harvesting the electricity generated by the EAPs, the EAP acts as a current source. When the switch is open, the current generated by the EAPs is collected on the electrodes, which form a capacitor, and energy is stored. At peak deflection when the velocity and current are at a minimum, the switch is closed and the charge is delivered to the load.

For sinusoidal motion with amplitude X the average power generated by an EAP device is

$$\begin{matrix}{P}_{avg} = \frac{E}{T} \\ = \frac{1}{2} \frac{{Q}^{2}}{CT} \\ = \frac{1}{2} ( \frac{{θ}^{2}}{2 π C ω} ) {( ω X )}^{2}\end{matrix}$$

where T=2π/ω is the oscillation period. Thus, the switched capacitor EAP acts like a damper with coefficient:

$$c = \frac{{θ}^{2}}{2 π C ω}$$

This shows that the damping coefficient is independent of the load, but as in the case of the EMI the generator would need to be impedance matched to the specific GHEED.

As another embodiment, EMI and EAP are coupled. The load can be equated to an equivalent mechanical damper. The respective equivalent dampers are added together, so that the overall equivalent damping coefficient is

$$c = \frac{{κ}^{2}}{R} + \frac{{θ}^{2}}{2 π C ω}$$

A normalized electrical generation coefficient may be defined:

$$β = \frac{cV}{qS}$$

where V is the flow velocity, q is the dynamic pressure, and S is an characteristic area. An optimal value of β produces the most power, and this value is dependent upon the speed of the flow and the equivalent damping coefficient.

EAPs and EMI are preferably configured to generate power over different phases of the cycle. EAPs produce electricity at maximum deflection, while EMI produces electricity at maximum velocity. This combination is preferable since the flow of power is more uniform over time. Impedance matching is important in system design.

As illustrated in FIG. 3 and FIG. 4, a preferred embodiment of the present disclosure is combining a galloping device 10 to convert the flow of water into an oscillating motion that will drive a generator 14.

The galloping energy harvester (10) comprises a prime mover or moving element (12), the moving element (12) in communication with a generator (14) and supported by a support structure typically comprising one or two legs, in this case two legs 11. The generator (14) produces electrical energy in response to motion of the moving element (12). The moving element (12) is preferably morphable and may morph actively or passively as described herein and/or to affect or change the fluid-structure interaction of the moving element (12). In preferred embodiments, the galloping energy harvester (10) is generally oriented substantially perpendicularly to a flowing fluid (20) such that the fluid (20) creates the motion of the moving element (12).

The preferred motion of the moving element (12) of the galloping energy harvester (10) is a galloping motion. At times, the motion of the galloping energy harvester (10), preferably may also or instead comprise an oscillation of the moving element (12) on an axis (22), or may comprise a linear motion of the axis (22) of the moving element (12).

In some embodiments, the morphing of the moving element (12) is passive, while in other embodiments, the morphing of the moving element (12) is active. Morphing may comprise a variation of one or more of a change in cross-sectional shape, cross-sectional area, and/or a change to surface texture of the moving element 12 or other component(s) of the energy harvester. In addition, morphing can relate to a change to the a structure of the energy harvester (10) such as stiffness of the moving element (12), a biasing element or spring thereof, a spring constant, or an element in the flowing fluid (20) upstream of the moving element (12). Active morphing may be continuous, or may be intermittent. Active morphing may require an actuator. Active morphing of a material property may not require an actuator. Energy input may be required to morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions. Morphing of moving element 12 and/or biasing element may be intermittent active and/or passive morphing, continuous active and/or passive morphing, cyclic active and/or passive morphing.

The galloping energy harvester (10) may be a single unit or a plurality of units. The units may be placed permanently in the fluid flow, or the units may be temporary or portable.

The galloping energy harvester (10) is used by placing it in a flowing fluid (20). The orientation of the flowing fluid is such that the moving element (12) is placed in motion by contact with the flowing fluid. Active and/or passive morphing may transpire. The mechanical energy of the moving element (12) is transformed to electrical energy by means of a generator (14) which is in communication with the moving element (12). In preferred embodiments, the morphing is passive. In other preferred embodiments, the morphing is active. Active morphing may be continuous, or may be intermittent.

The generator converts the mechanical motion of the oscillation into electricity. In preferred embodiments, the generator may be based on traditional electromagnetic induction (EMI), some other mechanical-to-electrical transduction pathway (such as deformation of an electroactive material), or some combination thereof. The galloping device relies on a limit cycle oscillation resulting from the nonlinear fluid-structure interaction between the water flow and the device. The galloping motion is induced by the water flow across the prism or moving element 12, and its effectiveness at different operating conditions depends upon the shape of the prism interacting with the flow. In order to maintain efficiency over a wide range of river operating conditions, preferred embodiments incorporate passive shape change or morphing into the prism, changing the hydrodynamic characteristics of the prism under varying operating conditions.

As shown in FIG. 3 and FIGS. 4A-B, the galloping device may include a morphing prism mounted as the moving element (12) on an elastic support (24) within legs 11. The prism 12 and supports 11 behave like a spring-mass system with its natural frequency being the frequency of oscillation. The generator (14) introduces damping to the system. The hydrodynamic characteristics of the prism 12 are determined by its cross-sectional shape. It is the interaction between the fluid and the structure that results in a sustained limit cycle oscillation that can be used for energy harvesting.

In some preferred embodiments of the GHEED 10, the devices may be from one to several meters in length. In some embodiments, the generation capacity will be in the range of 1 kW. In other embodiments, grid connected devices are capable of generating 50 to 100 kW of power.

Vortex Induced Vibration Energy Harvester. Vortex induced vibrations (“VIV”) represent a highly non-linear phenomenon in which a fluid interacts with a solid structure. Vortex induced vibration is a vibration induced in a structure by the vortices shed in the fluid by the structure or by a body upstream. The vortices are created by instabilities in the flow itself, and not necessarily by the motion of the structure. It is the fluctuations in the pressure field associated with the vortices that result in fluctuating forces on the structure, which in turn result in oscillating motion of the structure. In the presence of a rigid structure, the vortices would still be present along with the fluctuating pressure field; fluctuating forces would still be present and would act on the structure, which would not move because it is rigid.

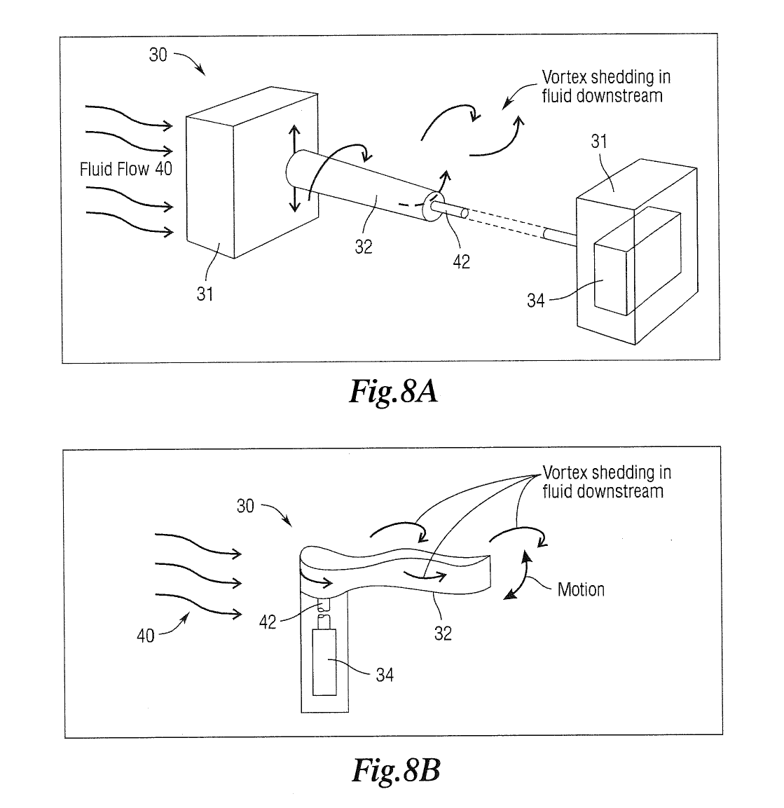

The response is analogous to a band-pass filter. As illustrated in FIGS. 8, VIV in its simplest form consists of a rigid cylinder mounted to elastic supports. Garcia., Elizabeth Maloney-Hahn, Prediction by Energy Phenomenology for Harnessing Hydrokinetic Energy Using Vortex-Induced Vibrations. PhD thesis. s.l.: University of Michigan, 2008. For a specific design, significant response was observed for flow velocities between 0.5 m/s and 1 m/s, corresponding to a ˜0.5 m/s ‘flow bandwidth.’ At peak performance (flow velocity of ˜0.8 m/s) the system operated at 22% efficiency; M. M. Bernitsas, K. Raghavan, Y. Ben-Simon, and E. M. H. Garcia, Vivace (vortex induced vibration aquatic clean energy): A new concept in generation of clean and renewable energy from fluid flow. s.l.: Department of Naval Architecture and Marine Engineering, Univ. of Mich., 2006; the efficiency is expected to be lower for other flow rates. Thus, VIV technology suffers from limited operational flow bandwidth.

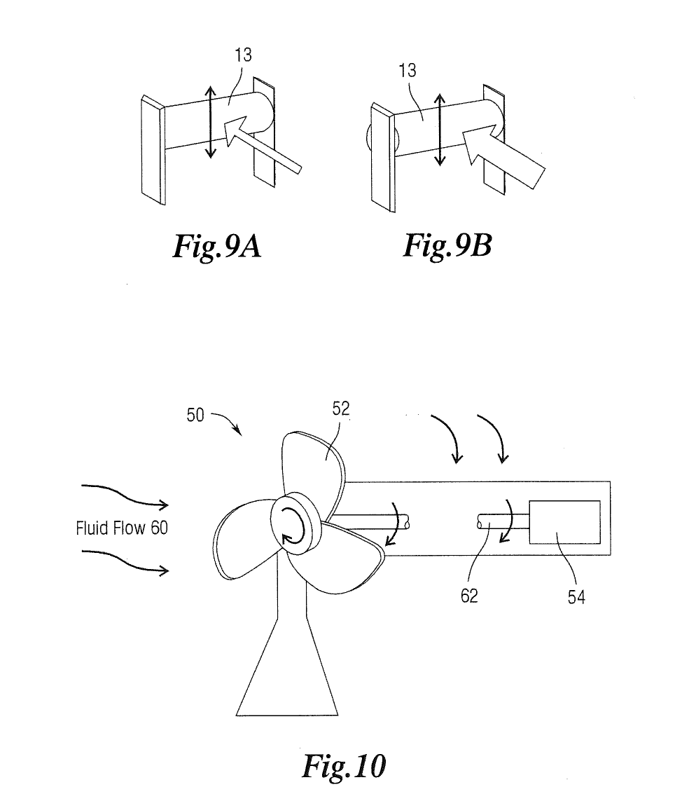

The magnitudes of the cut-in and cut-out flow velocities are a function of the control surface (cylinder) geometry and size. In one embodiment, FIG. 9, morphing of an expandable cylinder 13 that varies its cross sectional size as a function of inlet river flow rate increases performance bandwidth. In other preferred embodiments, FIGS. 6a and 6b, more complex geometry changing strategies address both cut-in/cut-out velocity and the height of the power generation curve. VIV energy harvesters, in an embodiment of the present disclosure, use morphing to expand harvest regime and efficiency.

As shown in FIG. 8a and FIG. 8b, the vortex induced vibration energy harvester (30) comprises a moving element (32) mounted on an elastic supports (not shown) within legs 31, the moving element (32) in communication with a generator (34). In preferred embodiments, the vortex induced vibration energy harvester (30) is oriented in a flowing fluid (40) such that the fluid (40) creates the motion of the moving element (32). The generator (34) produces electrical energy in response to motion of the moving element (32). The moving element or moving element (32) can actively or passively morph as described herein to affect fluid-structure interaction of the moving element (32).

The preferred motion of the moving element (32) of the vortex induced vibration energy harvester (30) is an oscillating motion of an axis (42). At times, the motion of the vortex induced vibration energy harvester (30), may comprise a linear displacement of the moving element (32) on the axis (42), or may comprise a galloping motion of the moving element (32).

In some preferred embodiments, the morphing of the moving element (32) is passive, while in other embodiments, the morphing of the moving element (32) is active. Morphing may comprise a variation of one or more of a change in cross-sectional shape, cross-sectional area, and/or a change to surface texture of the moving element 32 or other component(s) of the energy harvester. In addition, morphing can relate to a change to a structure of the energy harvester (30) such as stiffness of the moving element (32) and/or of a biasing element or spring thereof, a spring constant, or an element in the flowing fluid (40) upstream of the moving element (32). Active morphing may be continuous, or may be intermittent. Active morphing may require an actuator. Active morphing of a material property may not require an actuator. Energy input may be required to morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions.

The vortex induced vibration energy harvester (30) may be a single unit or a plurality of units. The units may be placed permanently in the fluid flow, or the units may be temporary or portable.

The vortex induced vibration energy harvester (30) is used by placing it in a flowing fluid (40). The orientation of the flowing fluid is such that the moving element (32) is placed in motion by contact with the flowing fluid. Active and/or passive morphing may transpire. The mechanical energy of the moving element (32) is transformed to electrical energy by means of a generator (34) which is in communication with the moving element (32). In preferred embodiments, morphing may be continuous, or may be intermittent. Morphing of moving element 32 and/or biasing element preferably may be intermittent active and/or passive morphing, continuous active and/or passive morphing, cyclic active and/or passive morphing.

Turbine Energy Harvester. The theoretical limit of turbine performance is defined as 59.4% per the Betz limit. Approaching this limit in both theory and practice requires turbine installation sites with one-dimensional laminar flow; this is assured only for turbines installed at deep sites. Morphing can expand performance of a hydroelectric energy device (HEED), including improved turbine performance. This is appealing as there is mounting evidence that application of traditional turbine concepts in rivers and streams, even in a diverted flow scheme, has an adverse effect on flora and fauna, fish migration, etc. In preferred embodiments of the HEED, morphing of turbines is used to mitigate these environmental impacts.

As shown in FIG. 10 the turbine energy harvester (50) comprises a moving element (52), the moving element (52) in communication with a generator (54). In preferred embodiments, the turbine energy harvester (50) is oriented in a flowing fluid (60) such that the fluid (60) creates the motion of the moving element (52). The generator (54) produces electrical energy in response to motion of the moving element (52). The moving element (52) is preferably morphable and may morph actively or passively as described herein and/or to affect or change the fluid-structure interaction of the moving element (52).

The preferred motion of the moving element (52) of the turbine energy harvester (50) is a rotating motion on an axis (62).

In some preferred embodiments, the morphing of the moving element (52) is passive, while in other preferred embodiments, the morphing of the moving element (52) is active. Morphing may comprise a variation of one or more of a change in cross-sectional shape, cross-sectional area, and/or a change to surface texture of the moving element 52 or other component(s) of the energy harvester. In addition, morphing can relate to a change to the a structure of the energy harvester (50) such as stiffness of the moving element (52), a spring constant, or an element in the flowing fluid (60) upstream of the moving element (52). Active morphing may be continuous, or may be intermittent. Active morphing may require an actuator. Active morphing of a material property may not require an actuator. Energy input may be required to morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions.

The turbine energy harvester (50) may be a single unit or a plurality of units. The units may be placed peinianently in the fluid flow, or the units may be temporary or portable.

The turbine energy harvester (50) is used by placing it in a flowing fluid (60). The orientation of the flowing fluid is such that the moving element (52) is placed in motion by contact with the flowing fluid. Active and/or passive morphing transpires. The mechanical energy of the moving element (52) is transformed to electrical energy by means of a generator (54) which is in communication with the moving element (52). In preferred embodiments, the morphing is passive. In other preferred embodiments, the morphing is active. Active morphing may be continuous, or may be intermittent. Morphing of moving element 52 may be intermittent active and/or passive morphing, continuous active and/or passive morphing, cyclic active and/or passive morphing.

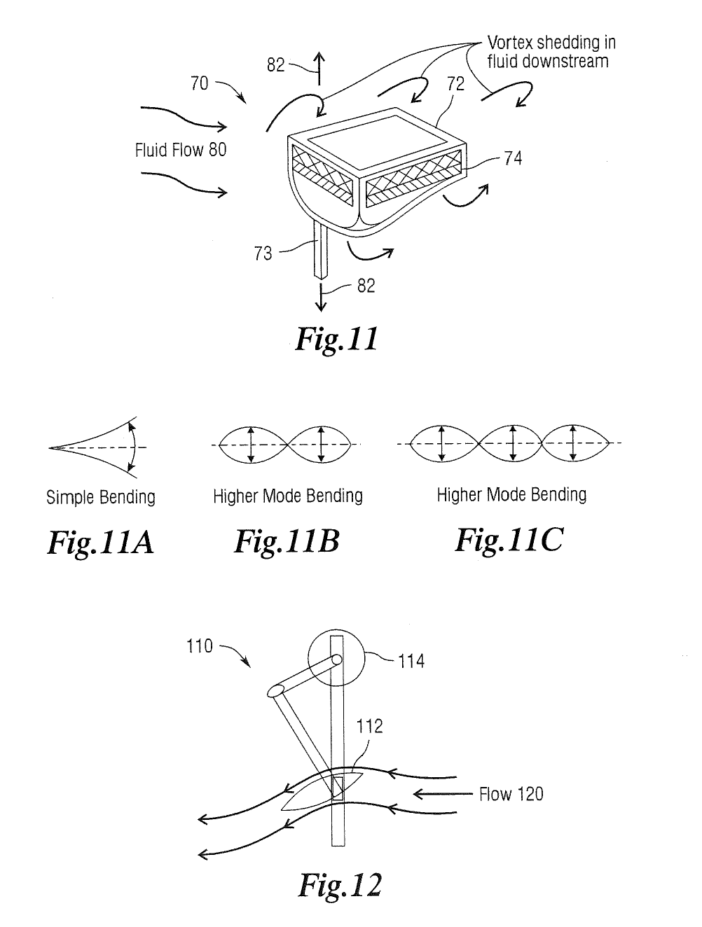

The Fluttering Flag and Piezo-bimorph Kinetic Energy Harvester. Multi-mode flutter is a vibration induced in a structure by the interaction between the fluid and the structure. In the absence of flow, the structure will have multiple modes of vibration that act independently (e.g., plunge and twist). In the presence of flow, the fluid-dynamics act to couple the modes of vibration. Simultaneously, the motion of the structure affects the fluid-dynamic forces by the effect of the structures motion through the flow. The result is to induce additional fluid-dynamic forces, which depend upon the characteristics of the structure's motion. The particular phasing between the modes vibration changes with flow speed causing the vibration characteristics of the structure, e.g., natural frequency and damping, to change. At a critical speed, the flutter speed, the structural vibrations are unstable and the vibrations grow until they reach a limit-cycle oscillation. The characteristics of this limit-cycle depend upon the nonlinear characteristics of the fluid-dynamics FIG. 11 illustrates two similar devices—oscillatory stimulation of an electroactive “fluttering flag” and a classic piezo-bimorph.

Pobering and Schwesinger proposed a concept which consists only of elastically deformable electroactive membranes. They claim “Power ratings of 71 μW per element could be achieved resulting in a power density of 70 W/m³ using the common mechanical theory.” Using estimates provided by Pobering and Schwesinger unfeasibly large quantities of electroactive materials would be required to develop a meaningful amount of power. The leading edges of these devices induce the vortex shedding responsible for device oscillation; there is again a limited band of flow speeds for which vortex shedding will occur. In another embodiment of the present disclosure, fluttering flag and piezo-bimorph harvestors use morphing to expand the harvest regime and efficiency of these non-EMI harvesters.

As shown in FIG. 11, the fluttering energy harvester or piezo-bimorph energy harvesters (70) comprises a moving element (72) movably mounted on mounting (73), the moving element (72) in communication with a generator (74). In preferred embodiments, the fluttering energy harvesters (70) is oriented in a flowing fluid (80) such that the fluid (80) creates the motion of the moving element (72). The generator (74) produces electrical energy in response to motion of the moving element (72). The moving element (72) is preferably morphable and may morph actively or passively as described herein and/or to affect or change the fluid-structure interaction of the moving element (72).

The preferred motion of the moving element (72) of the fluttering energy harvesters (70) is a waving motion or deformation of moving element (72). At times, the motion of the fluttering energy harvesters (70), may comprise a linear displacement of the moving element (72) on the axis (82), an oscillating motion of the moving element (72) on the axis (82), or may comprise a galloping motion of the moving element (72).

In some embodiments, the morphing of the moving element (72) is passive, while in other embodiments, the morphing of the moving element (72) is active. Morphing may comprise a variation of one or more of a change in cross-sectional shape, cross-sectional area, and/or a change to surface texture of the moving element 72 or other component(s) of the energy harvester. In addition, morphing can relate to a change to the a structure of the energy harvester (70) such as stiffness of the moving element (72) a biasing element or spring thereof, a spring constant, or an element in the flowing fluid (80) upstream of the moving element (72). Active morphing may be continuous, or may be intermittent. Energy input may be required to actively morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions.

The fluttering flag energy harvesters (70) may be a single unit or a plurality of units. The units may be placed permanently in the fluid flow, or the units may be temporary or portable.

The fluttering flag energy harvester (70) is used by placing it in a flowing fluid (80). The orientation of the flowing fluid is such that the moving element (72) is placed in motion by contact with the flowing fluid. Active and/or passive morphing transpires. The mechanical energy of the moving element (72) is transformed to electrical energy by means of a generator (74) which is in communication with the moving element (72).

In preferred embodiments, the morphing is passive. In other preferred embodiments, the morphing is active. Active morphing may be continuous, or may be intermittent. Morphing of moving element 72 may be intermittent active and/or passive morphing, continuous active and/or passive morphing, cyclic active and/or passive morphing.

Wingmill Kinetic Energy Harvester. When a wing is free to oscillate with degrees of freedom in both pitch (rotation) and plunge (vertical translation), power may be transferred from the fluid to the interacting wing. This was the basis for the 1981 McKinney and Delaurier wingmill, intended for use in air, but adaptable to water. The response of the wingmill is analogous to a high pass filter. As the free stream velocity is increased the device may simply oscillate faster thus producing higher levels of power. For a fixed geometry, peak performance cannot be realized under all conditions. While this device will display increased power generation with increased flow rate (no cutout), its performance and subsequently its efficiency vary with flow speed. Real rivers display considerable variation in flow speed. The coefficient of performance is expected to vary with flow speed, control surface geometry, and control surface orientation. See Davids, Scott T. A computational and experimental Investigation of a flutter generator. Master's thesis. s.l.: Naval Postgraduate School, 1999; The wingmill: An oscillating-wing windmill. Delaurier, W. McKinney and J., 2, s.l.: Journal of Energy, 1981, Vol. 5; Oscillating-wingpower generation. Kevin D. Jones, Max F. Platzer, and Scott Davids, s.l.: 3^{rd} ASME/JSME Joint Fluids Engineering Conference, FEDSM99-7050, July 1999; Lindsey, Keon. A feasibility study of oscillating-wing power generators. Master's thesis. s.l.: Naval Postgraduate School, 2002.

The effect of morphing on a wingmill is elaborated below. The governing equations of the wingmill are given to highlight the specific parameters that can be varied through morphing, which will affect the dynamics, and ultimately, the harvested energy from the device. Next the actual passive and active concepts for morphing the hydrofoil are presented. The effects of stall are not modeled.

The equation of motion for a wingmill is □

$$( 1 + {μ}_{1} {f}^{′ 2} + {μ}_{2} {g}^{′ 2} ) \frac{{d}^{2} φ}{d {τ}^{2}} + ( {μ}_{1} {f}^{′} {f}^{″} + {μ}_{2} {g}^{′} {g}^{″} ) {( \frac{d φ}{d τ} )}^{2} + ( {σ}_{1} + ( γ + {σ}_{2} ) {f}^{′ 2} ) \frac{d φ}{d τ} - γ {f}^{′} g + κ {ff}^{′} = 0$$

where the first term describes the inertia, the second describes centripetal acceleration, the third describes angular velocity effects including power generation and induced damping, and the last two describe stiffness effects. In this expression f and g are functions of the rotational angle φ, and time is normalized so that r=Ωt, where Ω=V/Y is the ratio of flow velocity to oscillation amplitude, and is a characteristic frequency for the problem, and t is the real time in seconds.

The parameters μ₁ and μ₂ act as inertial terms; in most design situations, the mass and moment of inertia of the wing are small compared to the inertia of the flywheel. The equation of motion reduces to □

$$\frac{{d}^{2} φ}{d {τ}^{2}} + ( {σ}_{1} + ( γ + {σ}_{2} ) {f}^{′ 2} ) \frac{d φ}{d τ} - γ {f}^{′} g + κ {ff}^{′} = 0$$

Consider the parameters σ¹ and σ₂ which are dampers.

$$\begin{matrix}{σ}_{1} = \frac{{c}_{φ}}{{I}_{S} Ω} \\ = \frac{{c}_{φ} Y}{{I}_{S} V}\end{matrix}$$

$$\begin{matrix}{σ}_{2} = \frac{{c}_{y} {Y}^{2}}{{I}_{S} Ω} \\ = \frac{{c}_{y} {Y}^{3}}{{I}_{S} V}\end{matrix}$$

c_{φ} is a rotational damper modeling a generator connected to the shaft; c_{y} is a linear damper modeling a generator connected to the slider, the characteristic dimension Y is the amplitude of wing pitch, and Iₛ is the mass moment of inertia of the shaft or flywheel.

Finally, the parameter κ, which acts as a stiffness, and parameter γ, which is determined by the ratio of fluid-dynamic forces to inertial forces, are given as

$$\begin{matrix}κ = \frac{{kY}^{2}}{{I}_{S} {Ω}^{2}} \\ = \frac{{kY}^{3}}{{I}_{S} V}\end{matrix}$$

$$\begin{matrix}γ = \frac{{qSC}_{L α} Y}{{I}_{S} {Ω}^{2}} \\ = \frac{{qSC}_{L α} {Y}^{3}}{{I}_{S} {V}^{2}} \\ = \frac{1}{2} \frac{ρ {SC}_{L α} {Y}^{3}}{{I}_{S}}\end{matrix}$$

Here q=ρV²/2 is the dynamic pressure, S is the planform area of the hydrofoil. C_{Lα}=∂C_{L}/∂α is the slope of the coefficient of lift curve, and is called the stability derivative. The stability derivative depends upon the shape of the hydrofoil.

There is a trade-off between the dynamic instability driving the motion and the fluid-dynamic damping that results in the wingmill operating at a steady-state condition (although not necessarily at a constant speed). In another embodiment of the present disclosure morphing is imposed on a wingmill to manipulate σ₁, σ₂, κ, and γ to optimize fluid-to-mechanical energy conversion.

FIG. 12 illustrates how morphing design affects fluid-to-mechanical and mechanical-to-electrical energy conversions. The fluid-to-mechanical performance of with a simple wingmill design has a hydrofoil attached to the connecting rod of a slidercrank mechanism. As the crank rotates, the angle of the hydrofoil changes and reaches a maximum angle of attack near mid-stroke, FIG. 12. In the rigid (not morphing) design, a symmetric hydrofoil is necessary in order for the flow to induce ‘lift’ during both the up and down strokes. (Lift is defined here as the flow force inducing the desired translation, where it is understood to be directionally variable.) However, wings with slight curvature provide improved lift and drag characteristics at certain Reynolds numbers and angles of attack. If such shapes are to be used in a wingmill, then the hydrofoil must go from concave-down during the up-stroke to concave-up during the down-stroke. In the equation of motion this shape change corresponds to direct manipulation of γ.

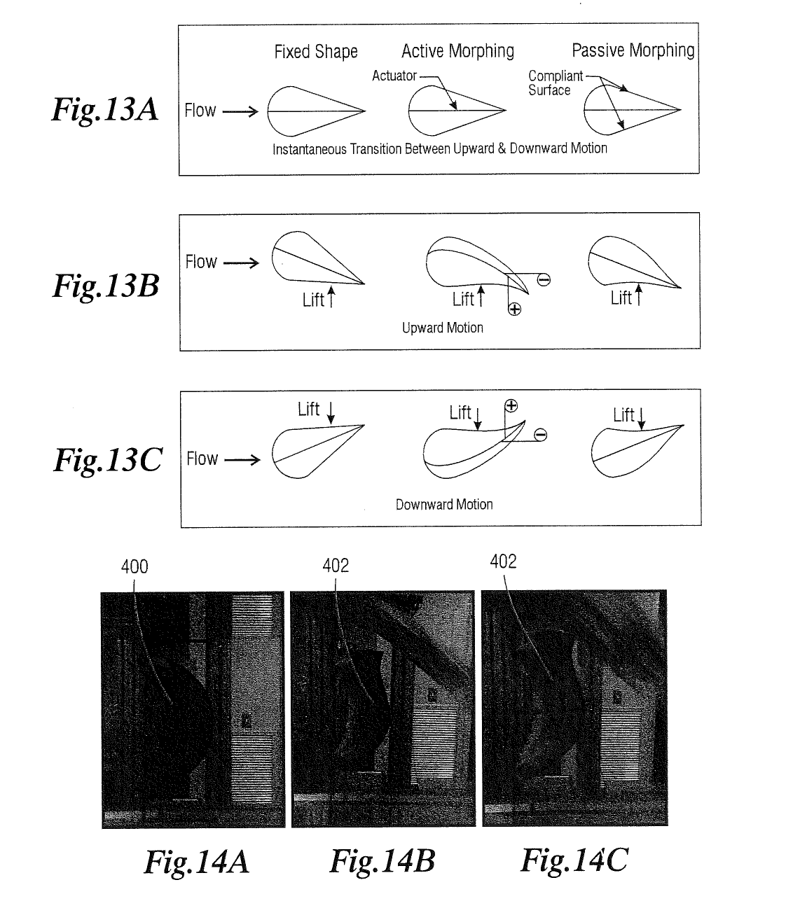

FIGS. 13a-13c illustrates the hydrofoil for scenarios of: no morphing (left), active morphing (center), and passive morphing (right). In embodiments of the present disclosure, both active and passive morphing display improved energy transformation as compared to no morphing. The choice between active and passive morphing becomes an exercise in balancing the pros and cons of each. Active morphing with an internal actuator such as a piezoelectric bimorph can achieve precise shape control while passive morphing is an inherently simpler design with no parasitic power drain or specialized control strategies.

In another preferred embodiment of the present disclosure, a middle ground between the illustrated passive and active morphing scenarios is envisaged. In one preferred embodiment of passive morphing, a control surface with discretely different but otherwise fixed stiffness properties (for instance a combination of latex and PVC) is employed. In another preferred embodiment, a single material with controllable stiffness properties is employed. This design employs active morphing, since some control strategy and power source will be required to induce local property change, but is also passive morphing.

In another preferred embodiment, material property manipulation is employed in the support structure. For instance, support ‘springs’ embody controllable stiffness and viscous (damping) properties. This corresponds to manipulation of κ.

In yet another preferred embodiment, active kinematic approach employs tabs (or ailerons) on the trailing surface of the hydrofoil. This control surface may be changed during the cycle. A further preferred embodiment uses a passive kinematic approach coupled to the control surface pivot point. Here the continuous rigid body rotation of the control surface inherent to the original design would be coupled to tab/aileron actuation in the opposite sense. The present disclosure is not limited to the embodiments shown, but establishes the utility of the broader hydroelectric morphing concept.

### Example 1

A wingmill with one hydrofoil 1 m wide and 10 cm chord oscillated with amplitude of 0.5 m in a 5 m/s flow without morphing. In water, the peak (optimal) power estimated for a rotational generator is ˜190 W, and for a linear generator is ˜310 W. Assuming these performance parameters to be additive, one small wingmill could generate almost 500 W. Power should scale at least proportionally with surface area; or alternatively, with appropriate spacing. Power should scale proportionally with the number of foils. In these estimates, the coefficient of performance (“C_{P}”) is quite small (0.003 in the rotational case, and 0.005 in the linear case). An explanation for the low coefficient of performance is the small surface area. With morphing, a C_{P} corresponding to at least several percent, rather than less than a percent, is achievable. Thus the expected power output per device would increase by an order of magnitude or more.

The simulation assumes uniform evolution of the target shape with flow speed as there is no precedent for expecting that the target shape at an intermediate flow rate would be convex if higher and lower speed target shapes are concave. Illustrated in FIGS. 6a and 6b illustrate hypothetical case in which optimum performance is expected to be achieved when control surface geometry displays increasing concavity with increased flow rate. Optimum control surface geometry as a function of flow rate has not been determined.

As illustrated in FIG. 12, the wingmill energy harvester (110) comprises a moving element (112), the moving element (112) in communication with a generator (114). The generator (114) produces electrical energy in response to mechanical motion of the moving element (1.12). The moving element (112) has morphing means affecting fluid-structure interaction of the moving element (112). In other preferred embodiments, the wingmill energy harvester (110) is oriented in a flowing fluid (120) such that the fluid (120) creates the motion of the moving element (112).

The preferred motion of the moving element (112) of the wingmill energy harvester (110) is an oscillating motion of an axis (122). At times, the motion of the wingmill energy harvester (110), may comprise a linear displacement of the moving element (112) pivoting on a slider (122).

In some embodiments, the morphing of the moving element (112) is passive, while in other embodiments, the morphing of the moving element (112) is active. Morphing may comprise a variation of one or more of a change in cross-sectional shape, cross-sectional area, and/or a change to surface texture of the moving element 112 or other component(s) of the energy harvester. In addition, morphing can relate to a change to the a structure of the energy harvester (110) such as stiffness of the moving element (112), a biasing element or spring thereof, a spring constant, or an element in the flowing fluid (120) upstream of the moving element (112). Active morphing may be continuous, or may be intermittent. Active morphing may require an actuator. Active morphing of a material property may not require an actuator. Energy input may be required to morph. In some embodiments, energy input may be continuous to maintain the active morphing. In more preferred embodiments, no energy input is required to hold or maintain the new shape or property. Morphing may take place at unscheduled times. Morphing may take place based upon flow or energy generation conditions. Morphing of moving element 112 and/or biasing element may be intermittent active and/or passive morphing, continuous active and/or passive morphing, cyclic active and/or passive morphing.

The wingmill energy harvester (110) may be a single unit or a plurality of units. The units may be placed permanently in the fluid flow, or the units may be temporary or portable.

The wingmill energy harvester (110) is used by placing it in a flowing fluid (120). The orientation of the flowing fluid is such that the moving element (112) is placed in motion by contact with the flowing fluid. Active and/or passive morphing transpires. The mechanical energy of the moving element (112) is transformed to electrical energy by means of a generator (114) which is in communication with the moving element (112). In preferred embodiments, the morphing is passive. In other preferred embodiments, the morphing is active. Active morphing may be continuous, or may be intermittent.

In each of the energy harvesters of the present disclosure, active morphing may comprise a sensor for providing data responsive to a predetermined condition of operation of the energy harvester, and a controller for controlling the operation of said morphing means in response to the data issued by the sensor.

In of each of the preferred energy harvesters of the present disclosure, the flowing fluid may be air or water.

In summary, morphing designs for hydroelectric energy devices provide opportunities for (i) Shallow or deep deployment; (ii) Reduced ecological impact; and (iii) Efficient performance over a broad flow regime.

In the foregoing Detailed Description, various features are grouped together in a single embodiment to streamline the disclosure. This method of disclosure is not to be interpreted as reflecting an intention that the claimed embodiments of the present disclosure require more features than are expressly recited in each claim. Rather, as the following claims reflect, inventive subject matter lies in less than all features of a single disclosed embodiment. Further, although elements of the described aspects and/or embodiments may be described or claimed in the singular, the plural is contemplated unless limitation to the singular is explicitly stated. The following claims are hereby incorporated into the Detailed Description, with each claim standing on its own as a separate preferred embodiment.

We claim:

1. An energy harvester for producing useable energy from fluid motion of a fluid medium, the energy harvester comprising:
a support structure affixed directly or indirectly to a foundation or mounting; wherein the support structure comprises one or more legs;
a morphable moving element movably supported by the support structure for oscillating movement along an axis of the support structure, wherein the axis is substantially perpendicular to a direction of the fluid motion;
a biasing element or spring for biasing the morphable moving element in a first direction along the axis; and
a converter for converting mechanical energy of the morphable moving element to useable energy.

2. The energy harvester of claim 1 wherein one or more of the morphable moving element, the biasing element or spring is capable of one or more of not morphing, active morphing, passive morphing, intermittent active and/or passive morphing, continuous active and/or passive morphing, cyclic active and/or passive morphing.

3. The energy harvester of claim 1 further comprising a sensor for providing data responsive to a predetermined condition of operation of the energy harvester; and a controller for controlling active morphing of the morphable moving element and/or the biasing element in response to the data from the sensor.

4. The energy harvester of claim 1 wherein the oscillating movement comprises galloping movement of the morphable moving element.

5. The energy harvester of claim 1, wherein the support structure comprises two legs, spaced apart and substantially parallel to one another wherein the morphable moving element is movably supported by and between the two legs.

6. The energy harvester of claim 1, wherein the support structure has only a single leg of single-piece or multi-piece construction.

7. The energy harvester of claim 6, wherein the single leg defines a streamlined portion near or contiguously with a location on the leg where the morphable moving element is attached to the single leg.

8. The energy harvester of claim 1, wherein the oscillating movement of the morphable moving element results from vortex induced fluid motion or galloping fluid motion or a combination thereof.

9. The energy harvester of claim 1, wherein the morphable moving element comprises areas or components wherein at least two of the areas and/or components have different structural stiffness values.

10. The energy harvester of claim 1, wherein the converter comprises a generator, an electromotive induction generator or an electroactive polymer generator.

11. The energy harvester of claim 1 wherein the morphable moving element experiences active and/or passive morphing dependent upon a variable parameter of the fluid motion comprising velocity or flow type.

12. The energy harvester of claim 1 wherein the morphable moving element experiences active and/or passive morphing at one or more points along an oscillation cycle traveled by the morphable moving element.

13. The energy harvester of claim 1 wherein the morphable moving element experiences active and/or passive morphing continuously, intermittently or cyclically along an oscillation cycle traveled by the morphable moving element.

14. An energy harvester for producing useable energy from fluid motion of a fluid medium, the energy harvester comprising:
a support structure affixed directly or indirectly to a foundation or mounting; wherein the support structure has only a single leg comprising single-piece or multi-piece construction;
a moving element movably supported by the support structure for oscillating movement along an axis of the support structure, wherein the axis is substantially perpendicular to a direction of the fluid motion;
a biasing element or spring for biasing the moving element in a first direction along the axis; and
a converter for converting mechanical energy of the moving element to useable energy.

15. The energy harvester of claim 14 wherein the moving element is non-morphable.

16. The energy harvester of claim 14 wherein one or more of the moving element, the biasing element or spring is capable of one or more of not morphing, active morphing, passive morphing, intermittent active and/or passive morphing, continuous active and/or passive morphing, cyclic active and/or passive morphing.

17. The energy harvester of claim 14, wherein the moving element comprises areas or components wherein at least two of the areas and/or components have different structural stiffness values.

18. The energy harvester of claim 14, wherein the single leg defines a streamlined portion near or contiguously with a location on the leg where the moving element is attached to the single leg.

19. A method for harvesting energy comprising the steps of:
a. placing a morphable moving element or prime mover in a flowing fluid;
b. morphing the moving element or prime mover; and
c. transforming the motion of the moving element or prime mover in response to the flowing fluid to electrical energy.

20. The method for harvesting energy of claim 19, wherein morphing comprises active morphing and/or passive morphing.
